(19) United States
(12) Patent Application Publication
(10) Pub. No.: US 2017/0034312 A1
(43) Pub. Date: Feb. 2, 2017

(54) Texting Communications System and Method for Storage and Retrieval of Structured Content originating from a Secure Content Management System

(71) Applicant: Anthony I. Lopez, JR., Dana Point, CA (US)

(72) Inventor: Anthony I. Lopez, JR., Dana Point, CA (US)

(21) Appl. No.: 14/812,965

(22) Filed: Jul. 29, 2015

(51) Int. Cl. H04L 29/06; H04W 4/14; H04L 29/08

(52) U.S. Cl. CPC H04L 67/42; H04L 67/1097; H04W 4/14

(57) ABSTRACT

The present invention includes a texting communications system and method where all content is structured, stored and retrieved from a secure content management system. Content is classified by way of the URL, Supporting URL, Content Detail URL, and Originating URL and categorically classified. Communication of content through text messaging can be performed instantaneously on any and all devices including but not limited to desktop/laptop, mobile and tablet devices. Content shared through the system is automatically rendered throughout all devices using the system. Social bilateral communication of content through the content management system is instantaneous. The present invention allows users to search for specific content by way of who, what, when and where. The system would allow users future retrieval of content stored in the secured content management system whether or not the content's supporting URL or originating URL still exists or has been deleted or modified.

### DEFINITIONS

Prior to describing the present invention, it is useful to provide definitions for some key terms used herein.

Content: broadly interpreted to include, without exclusion, digital resource that is, or could be accessed on the Internet such as image files, audio files, text files, video files, and any combinations and equivalents thereof.

Desired Content: broadly interpreted to include, without exclusion, any specific wanted data on a digital content platform, such as images, audio, text, video, and any combinations and equivalents thereof.

Atomic Content: broadly interpreted as a single element such as an image, text, or video that is not naturally divisible into smaller units.

Composite Content: broadly interpreted as a content type which has many atomic resources within it, for example, a html web page consisting of many script and image files.

Associated Content: broadly interpreted to include, without exclusion, any and all data of interest, desired or not, associated with an element—whether said element is atomic or composite. Most often, an element of content will have associated content within its composite parent content item.

URL (Uniform Resource Locator): broadly interpreted as a character string that constitutes a reference to atomic and/or composite resources on the World Wide Web.

Supporting URL or Source Location: a URL describing the location of an element or atomic content, which makes up composite content.

Originating URL or Source Location: a URL where original content comes from (typically composite).

Content Detail URL: some atomic content that is embedded in a particular instance of composite content will have associated code indicating a URL which provides additional information about said content. This URL is referred to as the content detail URL.

Web Browser (or browser): broadly interpreted as retrieving, presenting, and traversing information resources on the World Wide Web.

Contextual Information: broadly interpreted as data related to content, including but not limited to URL, supporting URL, originating URL, description, links, metrics, index, or identification.

Unstructured Content: broadly interpreted as information that either does not have a pre-defined data model or is not organized in a pre-defined manner.

Content Management System: broadly interpreted as a computer application that allows publishing, editing, modifying, organizing and deleting of content as well as maintenance from a central interface.

Storage System: broadly interpreted as a place where data is held in a digital form for access by a computer processor.

Device: broadly interpreted as a mechanical or electronic equipment or thing made for a particular purpose including but not limited to desktops/laptops, mobile devices, and tablet devices.

Texting: broadly interpreted as sending wording or content using a device.

### BACKGROUND OF THE INVENTION

Text messaging is the common term for the sending of “short” content messages from mobile phones using SMS (short message service). Most mobile phones and some personal digital assistants with on-board wireless telecommunications allow users to send and receive text messages providing a convenient and instant mode of communication and sharing of content between one or more users. Many users are increasingly communicating with one another using their phones or mobile devices than using a traditional device such as a desktop or laptop computer. Communication of content has become more popular through text messaging for both personal and business purposes, and with the technology to send content through texting, it is beginning to take over email messaging all together.

Users will use their mobile devices to share texts with content such as photos or videos through SMS. To share content using SMS, users typically must search their unstructured content on their mobile device then choose the receiver and send the text message. Initially finding specific content on their mobile device is time consuming since the content is typically unstructured as it does not have a pre-defined data model or is not organized in any pre-defined manner. It is cumbersome for users to attempt to separately store content then navigate through the device to retrieve a desired content, then attach said content to a text message. Further, after users attach content to text messages from their device storage they are essentially storing the same content in two or more locations resulting in duplicated content and unnecessary storage consumption. In addition, the receiver or receivers of the SMS who are receiving the same unstructured content typically would save said content on their mobile phones. Users must then save the content attachments on another storage medium, or multiple storage mediums, such as their hard drive or cloud storage system to further use said content again. The content saved is again unstructured which causes time delays when needing to use or share the content quickly to others.

When users desire content that was previously shared by way of SMS, typically the search for a particular desired text message is limited to only a keyword search of a massive aggregate of text messages a user may have acquired over time, which have not been deleted from their device storage. Typically a user cannot search text messages by way of content like photos or videos. The content itself cannot be found through conventional keyword search because it is unstructured and uncategorized. Although a keyword search may ultimately find a name, that name is not necessarily a person. Users are unable to search their text messages by way of a definitive who, what, when, and where. Further, the text messages are typically a collection of text by way of each individual or group, which are not separated in a categorical organized manner. Due to the lack of a viable content management system, which would organize content for search and retrieval the user is left with the tenuous, time-consuming task of looking for that analogy of a needle in an overgrowing, unorganized content haystack.

Therefore, a solution that would be more practical and desirable would be a system and method that allows users to securely send, store, search, retrieve, and share structured content text messages that originate from a secure content management system through any and all devices, including but not limited to a traditional computing device, mobile device or tablet device. A secure content management system assists users in converting all of their unstructured content into organized, structured content for specific search, retrieval and communication of content through text messages quickly. Users would then be able to bilaterally communicate their structured content immediately and instantaneously utilizing their devices with others, which interface with their respective content management systems simultaneously rendering all content on all devices.

### BRIEF SUMMARY OF THE INVENTION

The present invention includes a texting communications system and method where all content is structured, stored and retrieved from a secure content management system. Content is classified by way of the URL, Supporting URL, Content Detail URL, and Originating URL and categorically classified. Communication of content through text messaging can be performed instantaneously on any and all devices including but not limited to desktop/laptop, mobile and tablet devices. Content shared through the system is automatically rendered throughout all devices using the system. Social bilateral communication of content through the content management system is instantaneous. The present invention allows users to search for specific content by way of who, what, when and where. The system would allow users future retrieval of content stored in the secured content management system whether or not the content's supporting URL or originating URL still exists or has been deleted or modified.

The following description is presented to enable one of ordinary skill in the art to make and use the invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

### BRIEF DESCRIPTION OF THE DRAWINGS

FIG. 1 is a block diagram illustrating an exemplary embodiment of the texting communications system and method for the storage and retrieval of structured content originating from a secure content management system according to the present invention;

FIG. 2 is a flowchart illustrating an exemplary embodiment of a method of how the system determines, identifies, and stores specific elements according to the present invention;

FIG. 3 is a flowchart illustrating an exemplary embodiment of a method of how the system determines, stores and categorizes specific elements according to the present invention;

FIG. 4 is a flowchart illustrating an exemplary embodiment of a method of how the system is initialized from a client through the server process to retrieve content according to the present invention;

FIG. 5 is a flowchart illustrating an exemplary embodiment of a method of how the system is initialized from a client through the server process to send text message with categorized content according to the present invention;

FIG. 6 is a flowchart illustrating an exemplary embodiment of a method of how the system is initialized from a client through the server process to search for text messages according to the present invention;

### DETAILED DESCRIPTION

It should be appreciated that the present invention can be implemented in numerous ways, including as a process, or apparatus, a system, or a computer readable medium such as a computer readable storage medium or a computer network wherein program instructions are sent over optical or electronic communication links. It should be noted that the order of disclosed processes may be altered within the scope of the invention.

A detailed description of one or more preferred embodiments of the invention is provided below along with accompanying figures that illustrate by way of example the principles of the invention. While the invention is described in connection with the embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

An element according to the present invention encompasses digital content to include but not limited to meta data, text, image files, sound files, and video files. In order for the invention to properly provide and display interactive contextual information and originating URL for content, content is sent through a smart server wherein they are processed to either a database server or media store server where the content is separated into component content parts and associated URL, supporting URL, content detail URL, and originating URL. On the database server textual elements are indexed while on the media store server if applicable, a unique identifier is generated in association with an element that can be anything from an image file or video file. Requests from users are then sent back through the smart server to the user's device where the user can view all content containing the request. If pre-existing content is sent through the system, the system will filter out the duplicate content, replacing it with a unique identifier. In this manner, media is stored and retrieved without duplication, while still allowing varied meta data to be associated with said content.

In an exemplary embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device. The medium can be an electronic, magnetic, optical, electromagnetic, infrared, or semiconductor system (or apparatus of device) or a propagation medium.

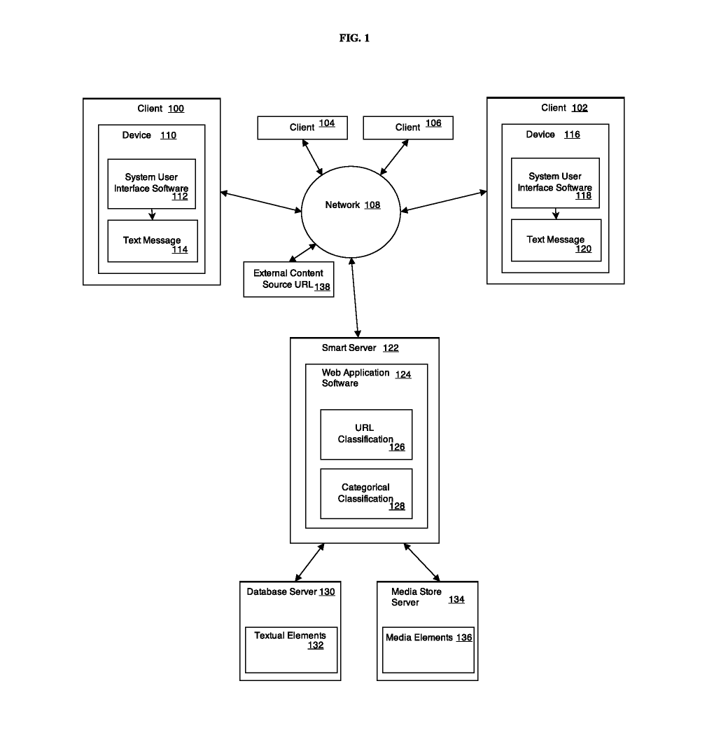

FIG. 1 is a block diagram illustrating an exemplary embodiment of a system displaying multiple hardware and software components of a texting communications system for the storage and retrieval of structured content originating from a secure content management system. A client's 100 device 110 interacting with a System User Interface Software 112 which displays text messages 114, interacts and sends client 100 commands through the network 108 to a Smart Server 122 where Web Application Software 124 executes said commands to determine, classify, store, search, and send content by way of URL Classification 126 and Categorical Classification 128 from an external content source URL 138 to a client's 102 device 116 interacting with a System User Interface Software 118 which displays text messages 120. The content is processed either to a Database Server 130 where textual element indexing 132 occurs or to a Media Store Server 134 where media elements are assigned unique identifiers 136 in association with relevant applicable content.

The client 100 and 102 can then retrieve the content from the Smart Server 122 through devices 110 and 116 where the System User Interface Software 112 and 118 requests all the elements or parts of the elements. All separated textual elements 132 from Database Server 130 and media elements with unique identifiers 136 from Media Store Server 134 are now transferred to the client 100 and 102 through the Web Application Software 124 from the Smart Server 122 through the network 108 interacting with the System User Interface Software 112 and 118 where the client 100 and 102 views the content on devices 110 and 116. The remainder of the elements may be retrieved at a later stage or not at all, as it is stored in the Smart Server 122.

Other clients, as represented in 104 and 106 running on other system user interface software may also be connected to the network 108. If the content from the URL is changed, moved, deleted or its access restricted, these clients will be unable to utilize said URLs for content retrieval. Whereas client 100 and 102 of this invention will be able to retrieve from the Smart Server 122 the archived content independently of its external existence on its originating server. Clients 104 and 106 connected to the network 108 may view clients' 100 and 102 text messages 114 and 120 from their own devices.

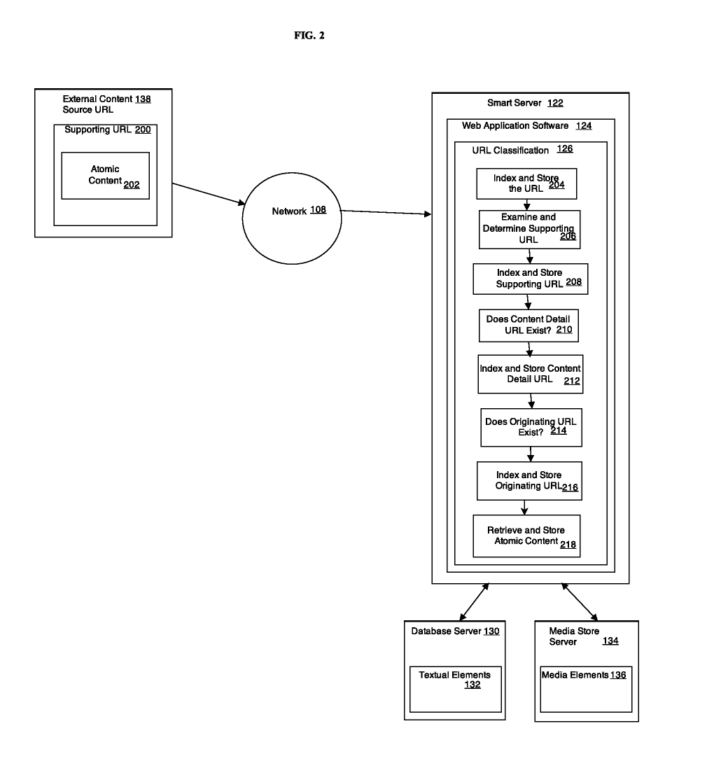

FIG. 2 is a flowchart that further illustrates an exemplary embodiment of a system and method of URL Classification 126 displaying through multiple hardware and software components whereby the atomic content 202 with a supporting URL 200 from an external content source URL 138 is retrieved through the network 108 by the Smart Server 122 where the Web Application Software 124 indexes and stores the URL 204, examines and determines supporting URL 206, indexes and stores supporting URL 208, determines content detail URL 210, indexes and stores content detail URL 212, determines originating URL 214, indexes and stores originating URL 216, and retrieves and stores atomic content 218.

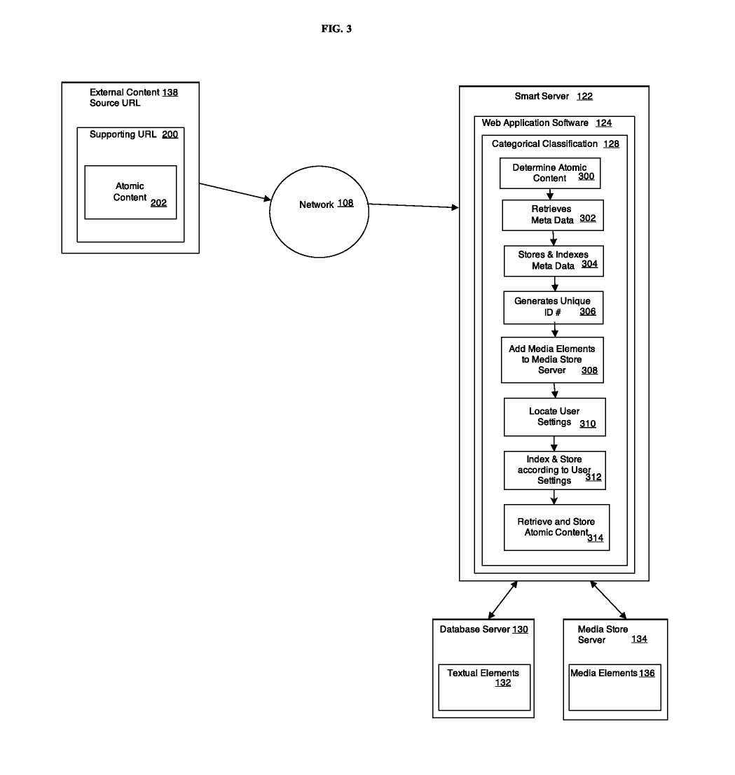

FIG. 3 is a flowchart that further illustrates an exemplary embodiment of a system and method of Categorical Classification 128 displaying through multiple hardware and software components whereby the atomic content 202 with a supporting URL 200 on an external content source URL 138 is retrieved through the network 108 by the Smart Server 122 where the Web Application Software 124 determines atomic content 300, retrieves meta data 302, stores and indexes meta data 304, generates unique id #306, adds media elements to media store server 308, locates user settings 310, indexes and stores according to user settings 312, retrieves and stores atomic content 314.

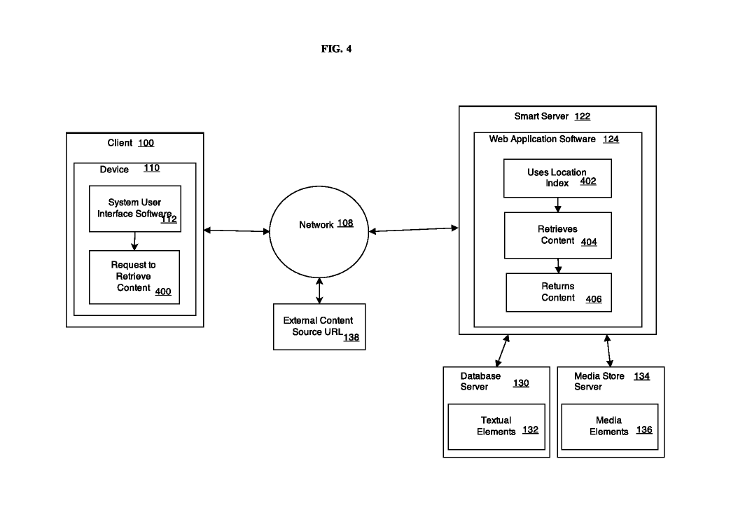

FIG. 4 is a flowchart that further illustrates an exemplary embodiment of a system and method displaying through multiple hardware and software components whereby requests to retrieve content 400 sent from the client 100 interacting with the System User Interface Software 112 through the network 108 are received by the Smart Server 122 where the Web Application Software 124 uses location index 402, retrieves content 404, and returns content 406 to the client 100 through the network 108 interacting with the System User Interface Software 112 where it is viewed on the device 110.

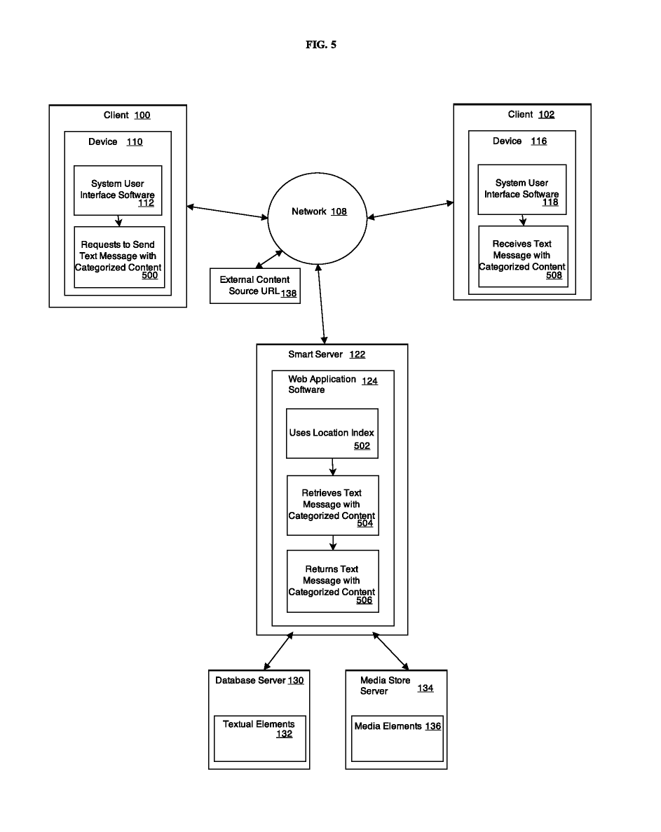

FIG. 5 is a flowchart that further illustrates an exemplary embodiment of a system and method displaying through multiple hardware and software components whereby client 100 requests to send text message with categorized content 500 interacting with the System User Interface Software 112 sent through the network 108 are received by the Smart Server 122 where the Web Application Software 124 uses location index 502, retrieves text message with categorized content 504, and returns text message with categorized content 506 where client 102 receives text message with categorized content 508 on a device 116 interacting with system user interface software 118.

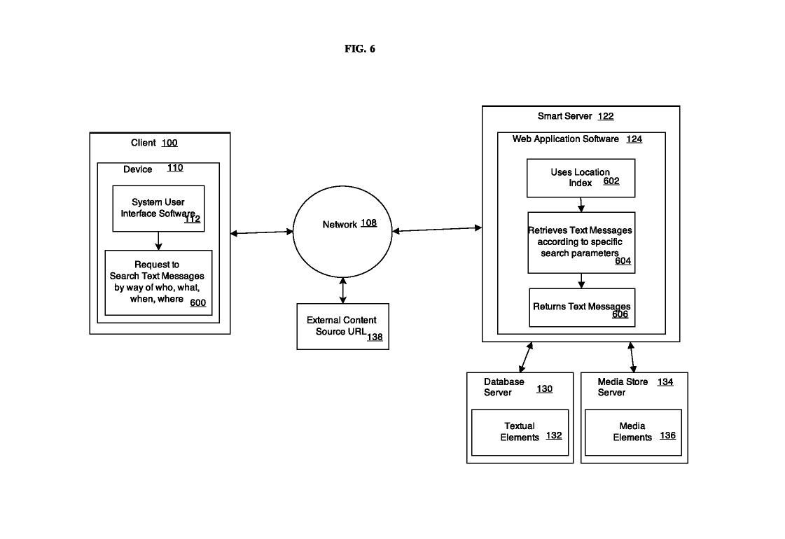

FIG. 6 is a flowchart that further illustrates an exemplary embodiment of a system and method displaying through multiple hardware and software components whereby client 100 requests to search text messages by way of who, what, when, where 600 interacting with the System User Interface Software 112 sent through the network 108 are received by the Smart Server 122 where the Web Application Software 124 uses location index 602, retrieves text messages according to specific search parameters 604, and returns text messages 606.

### REFERENCES

| | | |
|---|---|---|
| 8,271,596 | September 2012 | Haskins et al. |
| 8,291,032 | October 2012 | Lamb et al. |
| 20040205133 | October 2004 | Adler |
| 6,658,453 | December 2003 | Dattatri |
| 7,555,486 | June 2009 | Venguerov |
| 20100274750 | October 2010 | Oltean et al. |
| 8,392,538 | March 2013 | Lee |

What is claimed is:

1. A texting communications system and method, for the storage and retrieval of structured content originating from a secure content management system, the method comprising: of an operation to be performed on a smart server, perform the following steps on a smart server which further interacts with the appropriate Database Server and Media Store Server to: classify, store, retrieve, search, and communicate content and text messages; wherein the client device does not block thereby allowing one or more operations to be performed at the client device; receiving from the smart server the content, its URL, its supporting URL, and/or originating URL.

2. A method as recited in claim 1, the method comprising: of an operation to be performed on a smart server by way of URL Classification; in response to the client request, perform the following steps on a smart server which further interacts with the Database Server and Media Store Server to: index and store the URL, examine and determine supporting URL, index and store supporting URL, determine content detail URL, index and store content detail URL, determine originating URL, index and store originating URL, retrieve and store atomic content.

3. A method as recited in claim 1, the method comprising: of an operation to be performed on a smart server by way of Categorical Classification; in response to the client request, perform the following steps on a smart server which further interacts with the Database Server and Media Store Server to: determine atomic content, retrieve meta data, store and index meta data, generate unique id #, add media elements to media store server, locate user settings, index and store according to user settings, retrieve and store atomic content.

4. A method as recited in claim 1, the method comprising; of an operation to be performed on a smart server; in response to the client request at a client device, perform the following steps on a smart server which further interacts with the Database Server and Media Store Server to: use location index, retrieve content, and return content.

5. A method as recited in claim 1, the method comprising; of an operation to be performed on a smart server; in response to the client request at a client device, perform the following steps on a smart server which further interacts with the Database Server and Media Store Server to: use location index, retrieve text message with categorized content, and return text message with categorized content.

6. A method as recited in claim 1, the method comprising; of an operation to be performed on a smart server; in response to the client request at a client device, perform the following steps on a smart server which further interacts with appropriate database servers and media servers to: use location index, retrieve text messages according to specific search parameters, return text messages.

7. A method as recited in claim 1, wherein the client device displays the response via a browser.

8. A method as recited in claim 1, wherein the client device operates on the server data that allows for client side modification of server data received.

9. A method as recited in claim 8, wherein the client device being configured to receive user input that performs a change that requires an operation to be performed on the smart server, respond to the client input by: generating a request for the operation to be performed on the smart server, one or more operations to be performed in response to the request; and sending the response to the client device.

10. A method for a computer readable medium on a client device, the method comprising: receiving user input at a client device that performs a change that requires an operation to be performed on the smart server; in response to the user input, perform the following steps on the client device: generating request for the operation to be performed on the smart server; and sending the request to the smart server; wherein the client device does not block while waiting for the response from the smart server to the request, thereby allowing one or more operations to be performed at the client device after the client device sends the request and before the client device receives the response to the request; receiving the response, processing elements that were generated upon the user input.

11. A method as recited in claim 10, wherein the client device displays the response via a browser.

12. A method as recited in claim 10, wherein the client device operates on the server data that allows for client side modification of server data received.

13. A method as recited in claim 12, wherein the client device being configured to receive user input that performs a change that requires an operation to be performed on the smart server, respond to the client input by: generating a request for the operation to be performed on the smart server, one or more operations to be performed in response to the request; and sending the response to the client device.
